(19) United States
(12) Patent Application Publication
(10) Pub. No.: US 2026/0170316 A1
(43) Pub. Date: Jun. 18, 2026

(54) THREAD TILING FOR MEMORY LATENCY REDUCTION

(71) Applicant: Think Silicon Research and Technology Single Member S.A., Rion Achaias (GR)

(72) Inventors: Anastasios BARTSOKAS, Athens (GR); Dimitris GEORGAKAKIS, Athens (GR); Georgios KERAMIDAS, Patras (GR)

(73) Assignee: Think Silicon Research and Technology Single Member S.A., Rion Achaias (GR)

(21) Appl. No.: 18/567,544

(22) PCT Filed: Nov. 27, 2023
(86) PCT No.: PCT/GR2023/000063

§ 371 Date: Dec. 6, 2023

(51) Int. Cl. G06N 3/063

(52) U.S. Cl. CPC G06N 3/063

(57) ABSTRACT

A system and method for reducing memory latency utilizing thread tiling. The method includes receiving a tensor input as an array of values, the tensor having a size including a first dimension, a second dimension, and a third dimension; determining an operation type applied to the received tensor input; splitting the received tensor input into a plurality of tiles based on: a dimension of the array of values, a number of single instruction multiple data (SIMD) processors, and an amount of available internal memory; and processing each tile of the plurality of tiles on a SIMD processor.

### CROSS-REFERENCE TO RELATED APPLICATIONS

This application is a National Stage Application submitted under 35 U.S.C. 371 of International Application PCT/GR2023/000063 filed on Nov. 27, 2023, now pending. The contents of the above-referenced application are hereby incorporated by reference.

### TECHNICAL FIELD

The present disclosure relates generally to techniques for memory usage optimization in parallel processing, and specifically to tiling input tensors to optimize processing and memory utilization.

### BACKGROUND

Artificial Intelligence models, and specifically artificial neural networks (ANNs) are increasing in popularity as more and more uses are found for such computational models. As such, it is advantageous to introduce the capabilities provided by this technology into additional products, services, features, and the like.

However, not every application or hardware easily lends itself to the computation required to execute a neural network model. For example, convolutional neural networks (CNNs) are models that can be trained in image recognition, image classification, image analysis, natural language processing, and so on. These are all areas that have both professional and consumer interests.

It is apparent though, that a consumer often cannot afford the dedicated hardware which is required to execute such complex computations. For CNNs, for example, an input image of 100 by 100 pixels would require computation of 10,000 weights in a fully-connected layer. These types of computations are avoided by utilizing various processing techniques, however, executing a neural network is still computationally expensive.

Reducing the complexity of execution can translate into being able to execute more calculations, conserving power usage in existing calculations, conserving memory, and so on.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving a tensor input as an array of values, the tensor having a size including a first dimension, a second dimension, and a third dimension. Method may also include determining an operation type applied to the received tensor input. Method may furthermore include splitting the received tensor input into a plurality of tiles based on: a dimension of the array of values, a number of single instruction multiple data (SIMD) processors, and an amount of available internal memory. Method may in addition include processing each tile of the plurality of tiles on a SIMD processor. Other embodiments of this aspect include corresponding computer systems, apparatus, and computer programs recorded on one or more computer storage devices, each configured to perform the actions of the methods.

Implementations may include one or more of the following features. Method may include: determining a size of a kernel; and splitting the received tensor further based on the determined size of the kernel. Method may include: configuring the SIMD processor to perform the determined operation between the kernel and each tile of the plurality of tiles. Method where the size of the kernel includes: a value of the first dimension, a value of the second dimension, and a value of the third dimension. Method may include: selecting a first splitting scheme based on the largest value between the values of the first dimension, the second dimension and the third dimension of the input tensor; and selecting a second splitting scheme based on the largest value between the values of the first dimension, the second dimension and the third dimension of a filter. Method may include: selecting the first splitting scheme in response to detecting the first splitting scheme is identical to the second splitting scheme. Method may include: selecting the first splitting scheme in response to detecting that the first splitting scheme is not identical to the second splitting scheme and processor optimization is selected. Method may include: selecting the second splitting scheme in response to detecting that the first splitting scheme is not identical to the second splitting scheme, and memory optimization is selected. Method may include: splitting the tensor input into a plurality of slices based on the first dimension and the second dimension. Method may include: splitting each slice of the plurality of slices into a plurality of fibers based on the third dimension. Method may include: splitting the tensor input into a plurality of slices based on the second dimension and the third dimension. Method may include: splitting each slice of the plurality of slices into a plurality of fibers based on the third dimension. Method may include: splitting the tensor input further based on the largest value of: the first dimension, the second dimension, and the third dimension. Method may include: detecting a symmetry in the tensor input; and further splitting the tensor input into a plurality of tiles based on the detected symmetry. Method may include: splitting the received tensor input into a plurality of tiles further based on any one of: a size of an available register, a number of currently available registers, a length of an SIMD lane, and a combination thereof. Implementations of the described techniques may include hardware, a method or process, or a computer tangible medium.

In one general aspect, non-transitory computer-readable medium may include one or more instructions that, when executed by one or more processors of a device, cause the device to: receive a tensor input as an array of values, the tensor having a size including a first dimension, a second dimension, and a third dimension. Medium may furthermore determine an operation type applied to the received tensor input. Medium may in addition split the received tensor input into a plurality of tiles based on: a dimension of the array of values, a number of single instruction multiple data (SIMD) processors, and an amount of available internal memory. Medium may moreover process each tile of the plurality of tiles on a SIMD processor. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: receive a tensor input as an array of values, the tensor having a size including a first dimension, a second dimension, and a third dimension. System may in addition determine an operation type applied to the received tensor input. System may moreover split the received tensor input into a plurality of tiles based on: a dimension of the array of values, a number of single instruction multiple data (SIMD) processors, and an amount of available internal memory. System may also process each tile of the plurality of tiles on a SIMD processor. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: determine a size of a kernel; and split the received tensor further based on the determined size of the kernel. System where the memory contains further instructions which when executed by the processing circuitry further configure the system to: configure the SIMD processor to perform the determined operation between the kernel and each tile of the plurality of tiles. System where the size of the kernel includes: a value of the first dimension, a value of the second dimension, and a value of the third dimension. System where the memory contains further instructions which when executed by the processing circuitry further configure the system to: select a first splitting scheme based on the largest value between the values of the first dimension, the second dimension and the third dimension of the input tensor; and select a second splitting scheme based on the largest value between the values of the first dimension, the second dimension and the third dimension of a filter. System where the memory contains further instructions which when executed by the processing circuitry further configure the system to: select the first splitting scheme in response to detecting the first splitting scheme is identical to the second splitting scheme. System where the memory contains further instructions which when executed by the processing circuitry further configure the system to: select the first splitting scheme in response to detecting that the first splitting scheme is not identical to the second splitting scheme and processor optimization is selected. System where the memory contains further instructions which when executed by the processing circuitry further configure the system to: select the second splitting scheme in response to detecting that the first splitting scheme is not identical to the second splitting scheme, and memory optimization is selected. System where the memory contains further instructions which when executed by the processing circuitry further configure the system to: split the tensor input into a plurality of slices based on the first dimension and the second dimension. System where the memory contains further instructions which when executed by the processing circuitry further configure the system to: split each slice of the plurality of slices into a plurality of fibers based on the third dimension. System where the memory contains further instructions which when executed by the processing circuitry further configure the system to: split the tensor input into a plurality of slices based on the second dimension and the third dimension. System where the memory contains further instructions which when executed by the processing circuitry further configure the system to: split each slice of the plurality of slices into a plurality of fibers based on the third dimension. System where the memory contains further instructions which when executed by the processing circuitry further configure the system to: split the tensor input further based on the largest value of: the first dimension, the second dimension, and the third dimension. System where the memory contains further instructions which when executed by the processing circuitry further configure the system to: detect a symmetry in the tensor input; and further split the tensor input into a plurality of tiles based on the detected symmetry. System where the memory contains further instructions which when executed by the processing circuitry further configure the system to: split the received tensor input into a plurality of tiles further based on any one of: a size of an available register, a number of currently available registers, a length of an SIMD lane, and a combination thereof. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a tensor processor, utilized to describe an embodiment.

FIG. 2 is an example schematic illustration including a plurality of tensor-splitting schemes, utilized to describe an embodiment.

FIG. 3 is an example flowchart of a method for optimizing thread scheduling in tensor processing, implemented according to an embodiment.

FIG. 4 is an example schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for optimizing thread scheduling in tensor processing. An input tensor is received and tiles are generated therefrom, according to an embodiment. In some embodiments, the input tensor is split into tiles based on a determined operation type, a dimension of an array of values, a number of single instruction multiple data (SIMD) processors, a number of available threads, a number of available processing cores, an amount of available internal memory, a detected symmetry, a size of an available register, a number of available registers, a number of currently available registers, a length of a SIMD lane, a combination thereof, and the like.

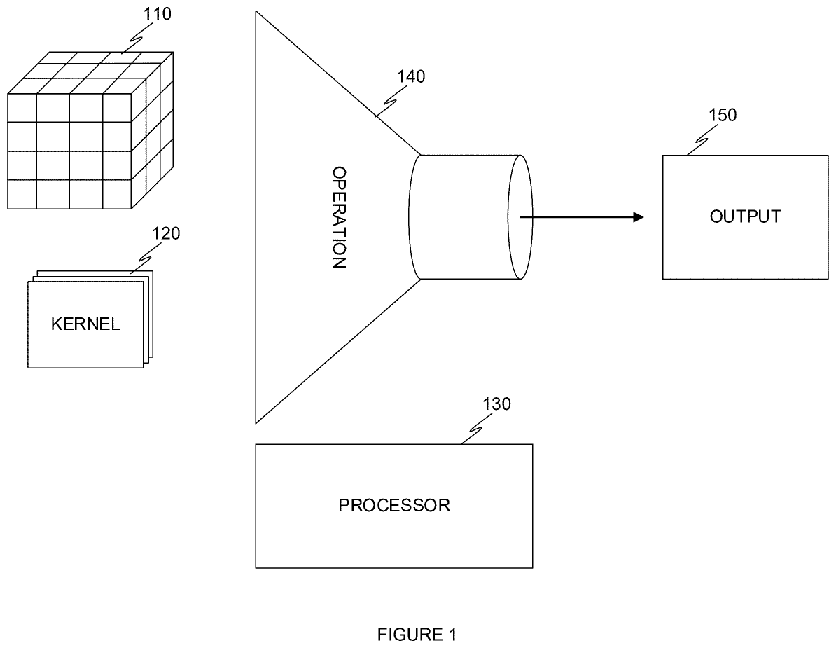

FIG. 1 is an example schematic diagram of a tensor processor, utilized to describe an embodiment. In an embodiment, a tensor 110 is implemented as a data structure having ‘N’ dimensions, where ‘N’ has a value of ‘2’ or greater.

In an embodiment, a tensor 110 has a dimension value of ‘3’, arranged, for an example, as an array of ‘X’ by ‘Y’ by ‘Z’, where ‘X’, ‘Y’, and ‘Z’ each have a value of ‘1’ or greater, and at least one of the values is larger than, or equal to, another value (e.g., the value of ‘Y’ is larger than, or equal to, the value of ‘X’).

In certain embodiments, a processor 130 is configured to process a tensor 110 by performing an operation 140 between the tensor 110 and a kernel 120. In an embodiment, the operation 140 is, for example, a convolution. According to an embodiment, the operation 140, when executed by the processor 130, generates an output 150. In an embodiment, an output 150 is a tensor.

In some embodiments, the processor 130 includes a plurality of processor cores. In certain embodiments, the processor 130 is implemented utilizing single instruction multiple data (SIMD) architecture. In an embodiment, the processor 130 is configured to process multiple threads, multiple threads in parallel, multiple threads serially, etc..

In an embodiment, it is advantageous to split the tensor into tiles, and process each tile individually. This allows better memory utilization, and better use of processor lanes (i.e., individual SIMD lanes). For example, parallelizing processing of a tensor by splitting into tiles allows to better utilize a parallel processor, a multithreaded processor, such as a graphical processor unit (GPU), and the like.

In an embodiment, a plurality of threads are generated, each thread based on a tile and an operation. In an embodiment, a plurality of methods can be used to generate tiles from the same tensor. In an embodiment, selecting a schema for tile generation results in different generated tiles. In some embodiments, a first tiling schema is preferable over a second tiling schema.

For example, preference is determined, according to an embodiment, based on a dimension of the tensor 110, based on a symmetry of the tensor 110, based on a number of SIMD lanes of the processor 130, based on a dimension of the output 150, based on a processor architecture (e.g., 8-bit architecture, 64-bit architecture, etc.), based on the number of available number of cores of hardware threads, a combination thereof, and the like.

In an embodiment, a first splitting scheme is selected to optimize processing based on tile generation from the input tensor 210. In some embodiments, a second splitting scheme is selected to optimize an output 150. In an embodiment, a splitting schema is optimized to an input, output, and the like, based on, for example, a predetermined rule.

For example, in an embodiment, a rule includes a condition, such as a check, utilized to determine if any dimension of the input is a multiple of a number of SIMD lanes available in the processor 130. As another example, in an embodiment, a rule includes a condition utilized to determine the number of available threads. In some embodiments, the splitting scheme is selected to optimize less execution time, increase hardware utilization, a combination thereof, and the like.

In some embodiments, where the first splitting scheme is identical to the second splitting scheme, the first splitting scheme is utilized to generate tiles from the input tensor 210. In certain embodiments, where the first splitting scheme is not identical to the second splitting scheme, a splitting scheme is determined based on a secondary condition.

For example, in an embodiment, a secondary condition is a memory utilization condition, a processor utilization condition, a combination thereof, and the like. In an embodiment, a memory utilization condition includes a rule utilized to determine if a splitting scheme utilizes a memory space, for example, above a predetermined amount (e.g., more than 80%). In an embodiment, the memory utilized is a scratchpad memory, an on-chip memory, a register file utilization, a combination thereof, and the like.

In certain embodiments, a splitting scheme is determined for each of a plurality of input tensors. In some embodiments, a splitting scheme is selected for a first group of input tensors, and a second splitting scheme is selected for a second group of input tensors.

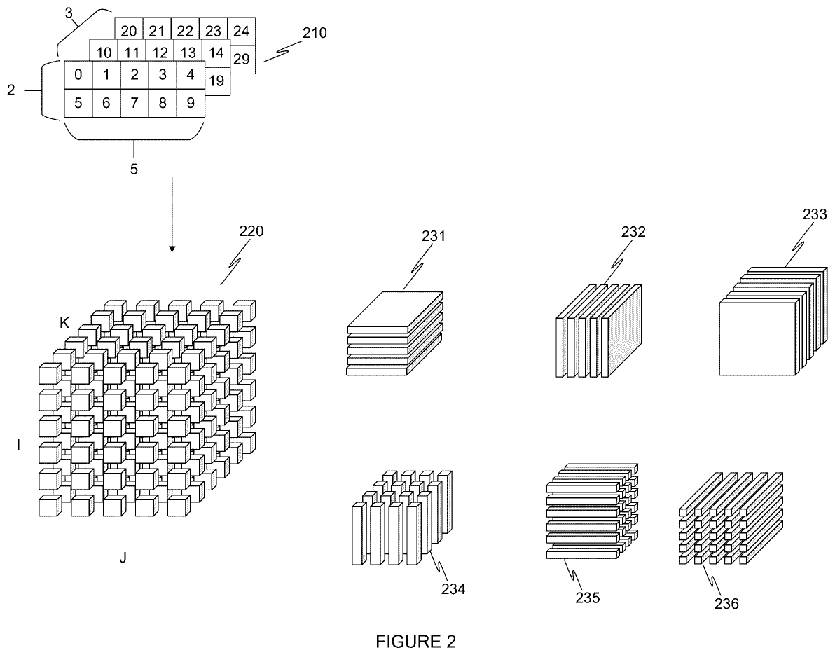

FIG. 2 is an example schematic illustration including a plurality of tensor-splitting schemes, utilized to describe an embodiment. In an embodiment, an input tensor 210 includes three dimensions, in this example the tensor is 2 by 3 by 5.

According to an embodiment, each value of the input tensor 210 is addressable by referencing a unique combination on a vector, e.g., a ‘point’ in the three dimensional space defined by the tensor structure. For example, in an embodiment, a tensor 220 includes a plurality of values stored as a three dimensional structure having a first dimension of length ‘I’, a second dimension of length ‘J’ and a third dimension of length ‘K’, where ‘I’, ‘J’, and ‘K’are integers having a value of ‘2’ or more.

In an embodiment, a splitting scheme is selected from a plurality of splitting schemes utilized to process the input tensor 210. In certain embodiments, the input tensor 210 is split into two arrays of three by five each (i.e., three by five tiles). In an embodiment, this splitting scheme corresponds to a horizontal slicing splitting scheme 231.

In certain embodiments, the input tensor is split into five tiles of three by two (e.g., five arrays of three by two each), corresponding to a lateral slicing splitting scheme 232.

In some embodiments, the input tensor 210 is represented as three arrays of two by five each. This splitting scheme corresponds to a frontal slice splitting scheme 233.

In an embodiment, the input tensor 210 is further split into tiles utilizing two splitting schemes. For example, in an embodiment, the input tensor 210 is split utilizing a horizontal slicing splitting scheme 231, and the resulting tiles are further split utilizing a lateral slicing splitting scheme 232, resulting in a tube fiber splitting scheme 236.

In some embodiments, the input tensor 210 is split utilizing the horizontal slicing splitting scheme 231, and the resulting tiles are further split utilizing a frontal slicing splitting scheme 233, resulting in a row fibers splitting scheme 235.

In certain embodiments, the input tensor 210 is split utilizing the lateral slicing splitting scheme 232, and the resulting tiles are further split utilizing the frontal slicing splitting scheme 233, resulting in a column fibers splitting scheme 234.

In some embodiments, each splitting scheme includes a predetermined scheme utilized to split the input tensor 210 into tiles.

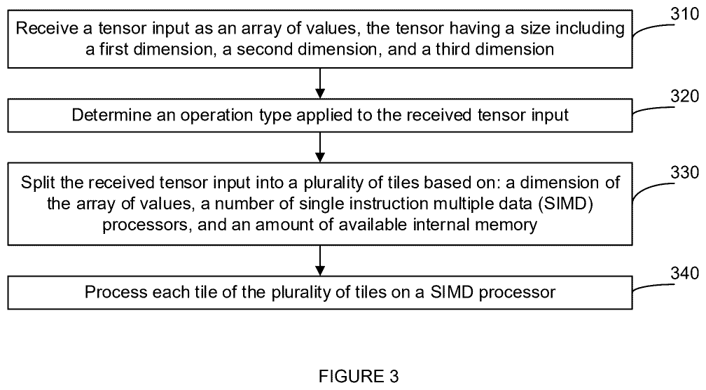

FIG. 3 is an example flowchart of a method for optimizing thread scheduling in tensor processing, implemented according to an embodiment. In an embodiment, optimizing thread scheduling in processing a tensor allows utilizing a parallel processor in an efficient manner, for example by maximizing scratchpad memory usage, and increasing processor usage.

At S310, an input tensor is received. In an embodiment, the input tensor is received as an array of values, a vector of values, a combination thereof, and the like. For example, according to an embodiment, the input tensor includes a size, which indicates a number of dimensions associated with the tensor. In some embodiments, the size includes a first dimension, a second dimension, and a third dimension.

In an embodiment, a number of ‘zero’ values (e.g., values which are equal to zero, values which are substantially zero, etc.) is determined. In certain embodiments, a portion of the tensor is determined to include all zero values, substantially zero values (e.g., values that are within a threshold of zero), and the like. In such embodiments, it is advantageous to take advantage of tensor sparsity to avoid processing a portion of a tensor that includes all zero values.

In an embodiment, each dimension has a length, which indicates a number of values in each dimension. In some embodiments, the values are fixed point values, floating point values, a combination thereof, and the like.

In an embodiment, a plurality of input tensors are received. In some embodiments, a first group of input tensors has a first size, and a second group of input tensors has a second size, which is not the first size. In certain embodiments, an order is indicated in the tensor size. In some embodiments, an ordinality indicates the tensor size (e.g., a tensor of 2 by 3 by 5 is not the same size as a tensor of 3 by 2 by 5).

At S320, an operation type is determined. In an embodiment, an operation is a convolution between the input tensor and a kernel. In an embodiment, a kernel is represented as an array, as a vector, as a combination thereof, and the like. In an embodiment, an operation is a dot product between the input tensor, a portion of the input tensor, and the like, and a kernel. In some embodiments, a kernel is also referred to as a filter.

In certain embodiments, a splitting scheme is selected based on the determined operation. In some embodiments, the splitting scheme is utilized to generate tiles based on the input tensor, each tile provisioned a processor thread for processing the tile based on the operation.

At S330, the input tensor is split into tiles. In an embodiment, splitting the received tensor input into a plurality of tiles is based on any one of: a dimension of the array of values, a number of single instruction multiple data (SIMD) processors, a number of available threads, a number of available processing cores, an amount of available internal memory, a detected symmetry, a size of an available register, a number of available registers, a number of currently available registers, a length of a SIMD lane, a combination thereof, and the like.

For example, according to an embodiment, the input tensor includes a dimension value (e.g., 32) which is a number that is a multiple of the number of SIMD lanes (e.g., 8 lanes per processor). In certain embodiments, it is beneficial to split the tensor into tiles along the dimension which is a whole multiple of the number of SIMD lanes, as this results in full utilization of all lanes during each processing cycle.

In certain embodiments, a value of a dimension, of each dimension, etc., of the kernel is determined. In some embodiments, a kernel has one dimension less than a filter (i.e., a filter is a number of ‘N’ kernels). In an embodiment, the kernel is utilized to perform a 1 dimensional convolution, a 2 dimensional convolution, a 3 dimensional convolution, a transposed convolution, a separable convolution, a dilated convolution, a deformable convolution, a depth-wise convolution, a combination thereof, and the like. In certain embodiments, each convolution type requires a different number of required registers. For example, a 3 by 3 kernel requires more registers than a 1 by 1 kernel, according to an embodiment.

In an embodiment, where the first splitting scheme matches the second splitting scheme, the first splitting scheme is utilized to split the input tensor into tiles. In some embodiments, where the first splitting scheme is not equal to the second splitting scheme, a secondary consideration is determined. For example, where the secondary consideration is predetermined to be full processor utilization, the first splitting scheme is selected. As another example, where the secondary consideration is predetermined to fully utilizing the memory, the second splitting scheme is selected.

In some embodiments, an input tensor is split into ‘slices’ (e.g., arrays) across a first dimension, slices across a second dimension, slices across a third dimension, and the like. In an embodiment, the input tensor is split into ‘fibers’, for example by slicing the tensor across a first dimension, and slicing the resulting slices across a second dimension.

At S340, each tile is processed. In an embodiment, a tile is a result of a split of the input tensor. In some embodiments, the tile is a vector of values, an array of values, a combination thereof, and the like. In an embodiment, processing a tile includes provisioning a thread in a thread pool to process the tile.

In some embodiments, processing a tile includes configuring a processor of a parallel processing architecture to process the tile and a kernel and perform an operation based on the tile and the kernel, such as a convolution.

In an embodiment, processing the tile generates an output. In some embodiments, the output is stored in a scratchpad memory of the processor. In certain embodiments, the output is a tensor (e.g., output tensor). In some embodiments, the output tensor is utilized as an input tensor at a second processing cycle (i.e., after processing of the input tensor is complete, and a full representation of the output tensor is stored in a scratchpad memory, on-chip memory, combination thereof, and the like).

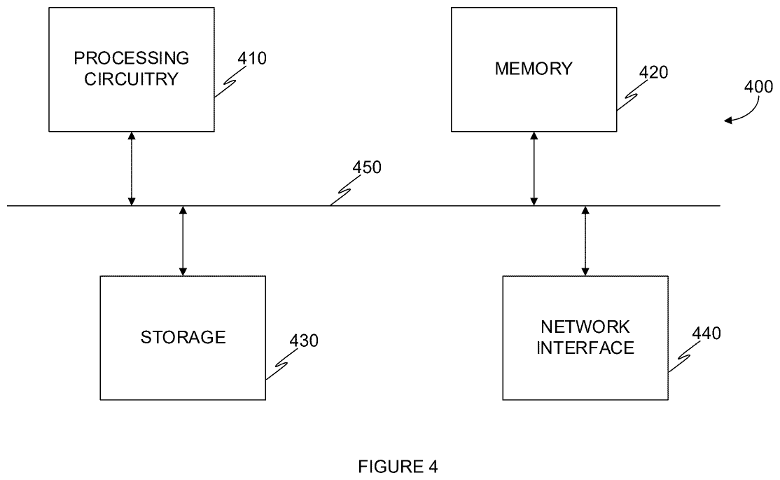

FIG. 4 is an example schematic diagram of a system 400 according to an embodiment. The system 400 includes a processing circuitry 410 coupled to a memory 420, a storage 430, and a network interface 440. In an embodiment, the components of the system 400 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof. In an embodiment, the memory 420 is an on-chip memory, an off-chip memory, a combination thereof, and the like. In certain embodiments, the memory 420 is a scratch-pad memory for the processing circuitry 410.

In one configuration, software for implementing one or more embodiments disclosed herein may be stored in the storage 430, in the memory 420, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for reducing memory latency utilizing thread tiling, comprising:
receiving a tensor input as an array of values, the tensor having a size including a first dimension, a second dimension, and a third dimension;
determining an operation type applied to the received tensor input;
splitting the received tensor input into a plurality of tiles based on: a dimension of the array of values, a number of single instruction multiple data (SIMD) processors, and an amount of available internal memory; and
processing each tile of the plurality of tiles on a SIMD processor.

2. The method of claim 1, further comprising:
determining a size of a kernel; and
splitting the received tensor further based on the determined size of the kernel.

3. The method of claim 2, further comprising:
configuring the SIMD processor to perform the determined operation between the kernel and each tile of the plurality of tiles.

4. The method of claim 2, wherein the size of the kernel includes: a value of the first dimension, a value of the second dimension, and a value of the third dimension.

5. The method of claim 4, further comprising:
selecting a first splitting scheme based on the largest value between the values of the first dimension, the second dimension and the third dimension of the input tensor; and
selecting a second splitting scheme based on the largest value between the values of the first dimension, the second dimension and the third dimension of a filter.

6. The method of claim 5, further comprising:
selecting the first splitting scheme in response to detecting the first splitting scheme is identical to the second splitting scheme.

7. The method of claim 5, further comprising:
selecting the first splitting scheme in response to detecting that the first splitting scheme is not identical to the second splitting scheme and processor optimization is selected.

8. The method of claim 5, further comprising:
selecting the second splitting scheme in response to detecting that the first splitting scheme is not identical to the second splitting scheme, and memory optimization is selected.

9. The method of claim 1, further comprising:
splitting the tensor input into a plurality of slices based on the first dimension and the second dimension.

10. The method of claim 9, further comprising:
splitting each slice of the plurality of slices into a plurality of fibers based on the third dimension.

11. The method of claim 1, further comprising:
splitting the tensor input into a plurality of slices based on the second dimension and the third dimension.

12. The method of claim 11, further comprising:
splitting each slice of the plurality of slices into a plurality of fibers based on the third dimension.

13. The method of claim 1, further comprising:
splitting the tensor input further based on the largest value of: the first dimension, the second dimension, and the third dimension.

14. The method of claim 1, further comprising:
detecting a symmetry in the tensor input; and
further splitting the tensor input into a plurality of tiles based on the detected symmetry.

15. The method of claim 1, further comprising:
splitting the received tensor input into a plurality of tiles further based on any one of: a size of an available register, a number of currently available registers, a length of an SIMD lane, and a combination thereof.

16. A non-transitory computer-readable medium storing a set of instructions for reducing memory latency utilizing thread tiling, the set of instructions comprising:
one or more instructions that, when executed by one or more processors of a device, cause the device to:
receive a tensor input as an array of values, the tensor having a size including a first dimension, a second dimension, and a third dimension;
determine an operation type applied to the received tensor input;
split the received tensor input into a plurality of tiles based on: a dimension of the array of values, a number of single instruction multiple data (SIMD) processors, and an amount of available internal memory; and
process each tile of the plurality of tiles on a SIMD processor.

17. A system for reducing memory latency utilizing thread tiling comprising:
a processing circuitry;
a memory, the memory containing instructions that, when executed by the processing circuitry, configure the system to:
receive a tensor input as an array of values, the tensor having a size including a first dimension, a second dimension, and a third dimension;
determine an operation type applied to the received tensor input;
split the received tensor input into a plurality of tiles based on: a dimension of the array of values, a number of single instruction multiple data (SIMD) processors, and an amount of available internal memory; and
process each tile of the plurality of tiles on a SIMD processor.

18. The system of claim 17, wherein the memory contains further instructions which when executed by the processing circuitry further configure the system to:
determine a size of a kernel; and
split the received tensor further based on the determined size of the kernel.

19. The system of claim 18, wherein the memory contains further instructions which when executed by the processing circuitry further configure the system to:
configure the SIMD processor to perform the determined operation between the kernel and each tile of the plurality of tiles.

20. The system of claim 18, wherein the size of the kernel includes:
a value of the first dimension, a value of the second dimension, and a value of the third dimension.

21. The system of claim 20, wherein the memory contains further instructions which when executed by the processing circuitry further configure the system to:
select a first splitting scheme based on the largest value between the values of the first dimension, the second dimension and the third dimension of the input tensor; and
select a second splitting scheme based on the largest value between the values of the first dimension, the second dimension and the third dimension of a filter.

22. The system of claim 21, wherein the memory contains further instructions which when executed by the processing circuitry further configure the system to:
select the first splitting scheme in response to detecting the first splitting scheme is identical to the second splitting scheme.

23. The system of claim 21, wherein the memory contains further instructions which when executed by the processing circuitry further configure the system to:
select the first splitting scheme in response to detecting that the first splitting scheme is not identical to the second splitting scheme and processor optimization is selected.

24. The system of claim 21, wherein the memory contains further instructions which when executed by the processing circuitry further configure the system to:
select the second splitting scheme in response to detecting that the first splitting scheme is not identical to the second splitting scheme, and memory optimization is selected.

25. The system of claim 17, wherein the memory contains further instructions which when executed by the processing circuitry further configure the system to:
split the tensor input into a plurality of slices based on the first dimension and the second dimension.

26. The system of claim 25, wherein the memory contains further instructions which when executed by the processing circuitry further configure the system to:
split each slice of the plurality of slices into a plurality of fibers based on the third dimension.

27. The system of claim 17, wherein the memory contains further instructions which when executed by the processing circuitry further configure the system to:
split the tensor input into a plurality of slices based on the second dimension and the third dimension.

28. The system of claim 27, wherein the memory contains further instructions which when executed by the processing circuitry further configure the system to:
split each slice of the plurality of slices into a plurality of fibers based on the third dimension.

29. The system of claim 17, wherein the memory contains further instructions which when executed by the processing circuitry further configure the system to:
split the tensor input further based on the largest value of: the first dimension, the second dimension, and the third dimension.

30. The system of claim 17, wherein the memory contains further instructions which when executed by the processing circuitry further configure the system to:
detect a symmetry in the tensor input; and
further split the tensor input into a plurality of tiles based on the detected symmetry.

31. The system of claim 17, wherein the memory contains further instructions which when executed by the processing circuitry further configure the system to:
split the received tensor input into a plurality of tiles further based on any one of: a size of an available register, a number of currently available registers, a length of an SIMD lane, and a combination thereof.
